(19) United States
(12) Patent Application Publication
(10) Pub. No.: US 2008/0110000 A1
(43) Pub. Date: May 15, 2008

(54) ROPE TIGHTENER AND SELF LOCKING ROPE TIE DOWN DEVICE

(76) Inventor: NELSON K. ORR, Tulsa, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 11/938,539

(22) Filed: Nov. 12, 2007

Related U.S. Application Data
(60) Provisional application No. 60/865,308, filed on Nov. 10, 2006.

(51) Int. Cl. F16G 11/00

(52) U.S. Cl. 24/130

(57) ABSTRACT

A rope tightening and securing device having a base member. A first lobe and a second lobe protrude from a first side of the base member. Each lobe has a first groove for receiving a segment of a rope. The first and second lobes define a slot therebetween. The device may be used to secure rope without tying knots in certain applications, to extend a length of rope, and to bypass a damaged section or rope.

### CROSS REFERENCE TO RELATED APPLICATIONS

This application claims the benefit of U.S. Provisional Patent Application No. 60/865,308 entitled “ROPE TIGHTENER AND SELF LOCKING ROPE TIE DOWN DEVICE,” filed Nov. 10, 2006, the contents of which are hereby incorporated by reference.

### FIELD OF THE INVENTION

This invention is a rope tightening device that attaches to a rope anywhere along a length of the rope to quickly tighten and secure the rope without using knots. More particularly, the device defines a groove having a ribbed surface to grip the rope for attaching to the rope and for securing the rope once desired rope tension is achieved.

### BACKGROUND OF THE INVENTION

Frequently, it is necessary to secure a load in place by way of a rope, wire, cable or other member (referred to herein collectively as “rope”). To secure a load, one end of the rope is typically secured to a fixed anchoring member. Specific examples of use of this type of securing arrangement include utilizing rope to secure a tarp that is positioned over material on a truck or other transport vehicle. A further example is using rope to support branches laden with heavy fruits, or any of a wide variety of other applications wherein a rope or cable is used to secure and hold material or cargo securely in a desired position. Material may be heavy and difficult to manage and secure. Therefore, various devices have been employed to apply tension on a rope or cable for securing loads or cargo.

One commonly used arrangement for tensioning a rope in applications where the rope is relatively flexible involves tying a knot in a portion of the rope and leaving a loop extending therefrom, running the rope around an anchoring member, back through the loop, then pulling tension to achieve the desired tightness, and then back to the anchoring member where the rope can be securely tied off. This arrangement functions generally in the same manner as a pulley or block-and-tackle arrangement, giving the user a mechanical advantage when tensioning the rope prior to securing its running or free end to the anchoring member. This method has disadvantages associated with tying the knot, which is inconvenient and frequently difficult to untie when the load is to be released. Further, the knot may cause damage to the rope.

Other devices have been used to assist a user in tensioning a rope for securing a load of material. However, many of these devices are inconvenient or difficult to use, or may result in weakening of a portion of the rope. Thus, a need has arisen for a simple, easily used device for tensioning a rope, wherein the device may be quickly and easily installed. The device should be durable and preferably also give the user a mechanical advantage to assist him or her in tensioning the rope.

### SUMMARY OF THE INVENTION

The present invention is a tensioning device that is inexpensive to manufacture and is useful for various rope tensioning applications. Further, in the preferred embodiment, the device has no moving parts. The device of the invention is a versatile rope tightening device that can be used anywhere along a length of rope that is being used to hold, tie down, or secure a load or item. In certain applications, the device of the invention eliminates a need for tying a knot even at the securing point.

Advantages of the invention include the ability to save time by securing loads using small diameter line without using knots. Anticipated applications include use on a truck or trailer and use inside a box truck or trailer. Further, the device is ideal for camping purposes, such as for securing tents, tarpaulins, canvas awnings, netting and clothes lines. The device facilitates stretching a line taught between two points to securely hold an object tied in place by maintaining tension on the rope used to secure the object.

The device allows tension in a rope to be quickly and easily adjusted without untying and tying knots. Rope tension held by the securing, clamping grip of the device may be easily adjusted.

Other contemplated uses for the device include adjusting a boat anchor length or attaching a line to a tree while a boat is beached. The device is effective for setting up sports netting, such as volleyball and badminton nets since the tightness of the ropes may be quickly adjusted. Further, the device can be used to hang items such as bicycles, canoes, ladders, etc. from a ceiling and may be used to hoist items and to secure items in place.

When felling a tree, the device may be used to attach a taught line to the tree to direct the fall of the tree. The device can be used to bypass a damaged part of rope while still holding the rope tight and secure. The device can be used to tie up branches in a tree, such as fruit trees, and quickly make adjustments without untying and tying knots.

The device can be used with multiple types of material used in rope, string, cord, or twine, e.g., from manila or hemp type rope, nylon braided or twisted types of rope, and line used by individuals to secure loads or to anchor various items. For purposes of this application, the term rope will be used to refer to any type of rope, string, cord, twine or other flexible elongate members. The device may be used in any application where a rope needs to be tightened between two points.

In the preferred embodiment, the device has two protuberances or lobes that have grooves or channels for receiving the rope. The channels are preferably tapered to facilitate use with many sizes of rope that can be secured within the device of the invention, i.e., rope having a very small diameter, such as twine (typically 1/16″ to ⅜″ diameter) up to larger diameters of rope. The ability to grip different sizes of rope allows the device to be suitable for diverse applications. As an example, the most common sizes and types of rope used in the securing of material or loads in a truck or trailer is between 3/16″ and ⅜″ braided nylon.

In summary, the device of the invention is very simple to use for securing a length of rope to secure a load, adjusting the tightness of a sports net, securing a tent or awning, or for hanging an item from a ceiling. One benefit of this device is its simplicity and quickness in placing the device into service.

### BRIEF DESCRIPTION OF THE DRAWINGS

FIG. 1 is a schematic of a length of rope.

FIG. 2A is a perspective view of the rope tightening and securing device of the invention.

FIG. 2B is a side elevation view of the device of FIG. 2A.

FIG. 2C is a plan view of the device of FIG. 2A.

FIG. 2D is a bottom view of the device of FIG. 2A.

FIG. 2E is an end elevation view of the device of FIG. 2A.

FIG. 3 is a perspective schematic view of the device of FIG. 2A being used to secure a load in a preferred configuration.

FIG. 4 is a perspective view showing the device in use to bypass a damaged part of a length of rope.

FIG. 5 is a perspective view of the device of FIG. 2A being used to join separate pieces of rope or to bypass a damaged rope segment and a second device to assist in tensioning the rope.

### DETAILED DESCRIPTION OF THE PREFERRED EMBODIMENTS

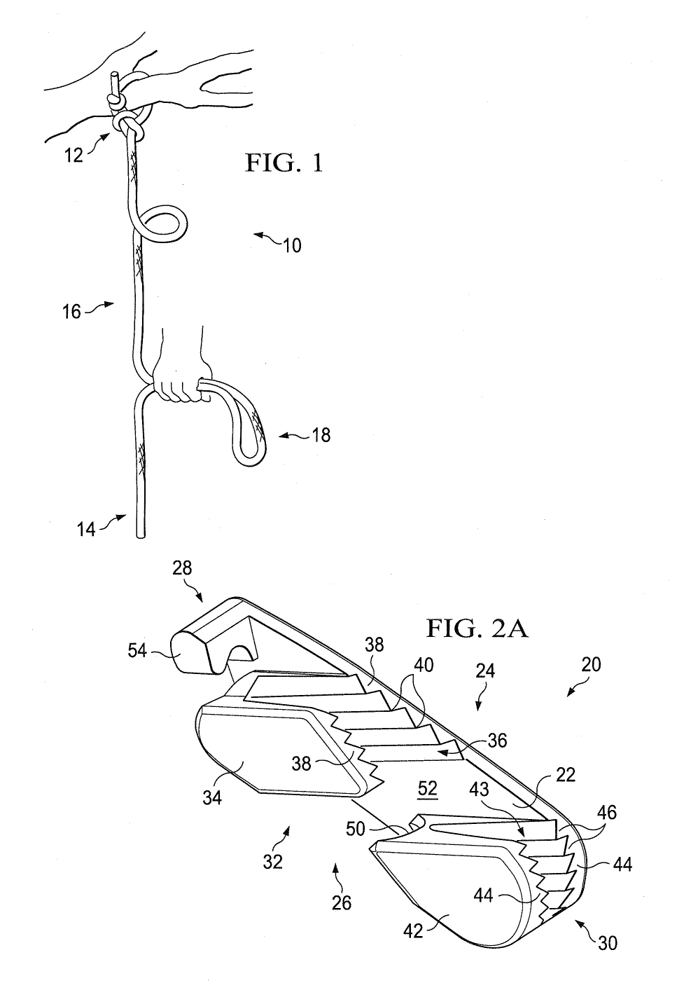

In describing how the invention works or is used in the application of securing or tightening a length of rope 10, it is necessary to describe the terms commonly associated in using and securing rope 10. Referring first to FIG. 1, the working end 12 of rope 10 is shown. Working end 12 is the end of rope 10 that is used to secure rope 10 to an anchor point. The running end 14 of rope 10 is the end of rope 10 that is not rigged, i.e., the free end. The standing part 16 of the rope 10 is the portion of rope 10 that is not fastened at the rigging point. Bight 18 is a “U” shaped bend in rope 10 that orients a portion of rope 10 back parallel with itself. When rope 10 is “taught”, this refers to tensioning rope 10 to remove the slack from rope 10.

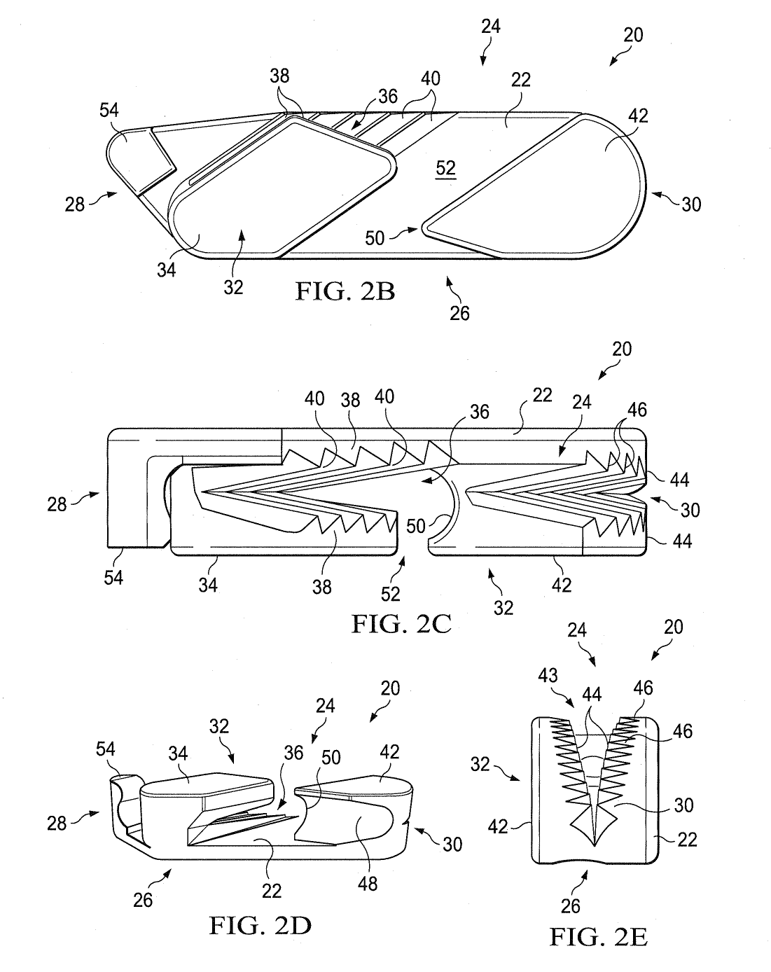

Referring now to FIGS. 2A-2D, a rope tightening and securing device is designated generally 20. Device 20 has a base member 22. Device 20 has a top 24, a bottom 26, a first end 28, a second end 30 and a first side 32. Device 20 may be made of nylon, similar plastic polymer material, or other suitable materials.

A first lobe 34 is affixed to said first side 32 of base member 22 proximate first end 28. First lobe 34 has a first groove 36 accessible from top 24 for receiving a segment of standing portion 16 of rope 10. First groove 36 is defined by a pair of first locking jaws 38. On an inner surface of first locking jaws 38 is a plurality of first ridges or first gripping members 40. First gripping members 40 are preferably oriented at an angle that is approximately 50 degrees with respect to a lower edge of base plate 22.

A second lobe 42 is affixed to first side 32 of base member 22 proximate second end 30. Second lobe 42 has a second groove 43 accessible from top 24 for receiving a segment of standing part 16 of rope 10. Second groove 43 is defined by a pair of second locking jaws 44. On an inner surface of second locking jaws 44 is a plurality of second ridges or second gripping members 46. Second gripping members 46 are preferably oriented at an angle that is approximately 50 degrees with respect to a lower edge of base plate 22. Second lobe 42 further defines a guide channel 48 (FIG. 2D) on bottom 26. A pulley surface 50 is formed on interior end of guide channel 48.

First lobe 34 and second lobe 42 define a slot 52 therebetween. A tang member 54 extends from first end 28 and defines a second slot between said tang member 54 and said first lobe 34.

i. Description for Using the Device to Tighten a Length of Rope, to Secure a Load, or Item

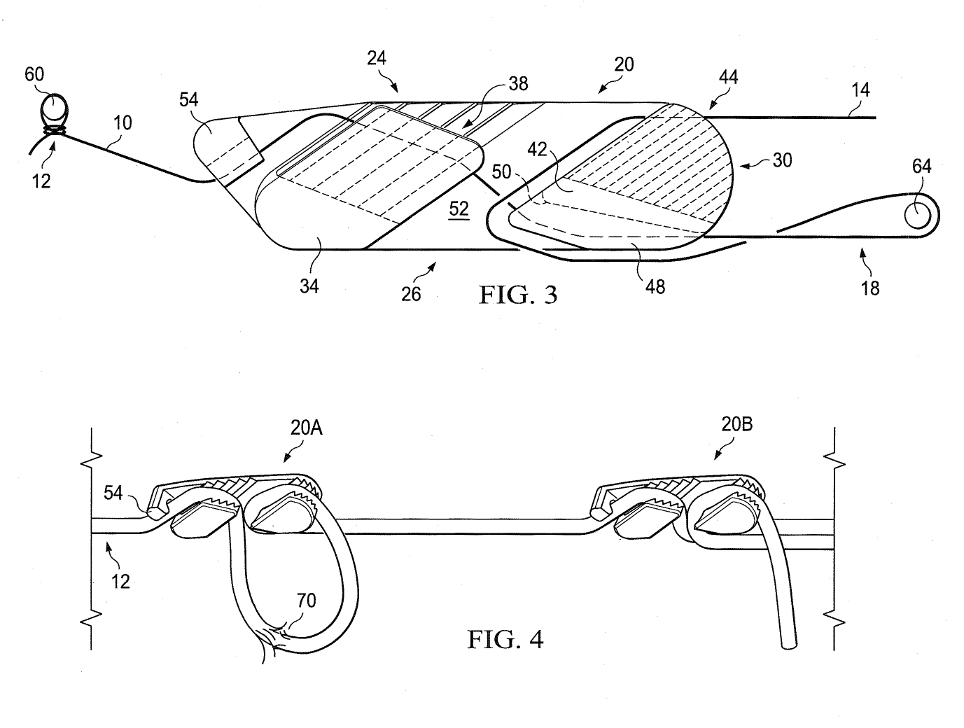

Referring now to FIG. 3, the following describes use of device 20 for purposes of securing a load on a trailer, in a truck, or in a cargo box, all of which may be secured by using the same technique.

First, a user secures working end 12 of rope 10 (schematically represented in FIG. 3) to a first anchor point 60 or tie off point, such as the side rail of a trailer or other tie down. Next, rope 10 is passed over material, e.g. lumber or other materials, to be secured. Then rope 10 is passed around a secured second anchor point 64 opposite first anchor point 60 to form a bight 18 in rope 10. Rope 10 is then pulled taught.

A portion of standing part 16 of rope 10 is then slipped into tang member 54. The placement of device 20 may be anywhere along standing part 16 of rope 10 so long as there exists enough room to tension to rope 10.

Once device 20 is located onto standing part 16 of the rope 10, device 20 may freely slide in either direction along rope 10. When device 20 is in optimum position for tensioning, standing part 16 of rope 10 is engaged with first locking jaws 38. Rope 10 is then directed over top 24 of first lobe 34, through slot 52, and into guide channel 48 on bottom 26 of second lobe 42.

Rope 10 exits guide channel 48 at second end 30 and passes around second anchor point 64, thereby forming bight 18. Rope 10 then travels back toward device 20, and back into guide channel 48. Rope 10 is directed around pulley surface 50 and up into second locking jaws 44 on top 24 of second lobe 42. Running end 14 of rope 10 is then pulled until desired tightness of rope 10 is achieved. The tension in rope 10 forces rope 10 tightly into second locking jaws 44 in second lobe 42, which functions as a self locking device.

The amount of tension that can be applied to the rope 10 will depend on the type and size of rope 10 being used. To loosen tension, running end 14 of rope 10 is grasped and pulled to lift rope 10 from second locking jaws 44 of second lobe 42. Lifting rope 10 allows a user to loosen rope 10 enough to place additional or larger material to be secured. Rope 10 may then be re-tightened using the previously described method.

A user should not attempt to secure a load heavier than the rated breaking strength of the rope being used. It is important to use an appropriately sized rope 10 in relation to item being secured. The user should be aware of the breaking strength of rope 10 being used in relation the load or item being secured.

ii. Description for Using the Device for Hoisting an Object From a Vertical Anchor Point

Still referring to FIG. 3, the following describes a method of using device 20 to secure rope 10 to a first anchor point 60 such as a hook or eye that is secured in the ceiling for the purpose of lifting and securing a canoe or bicycle, i.e., second anchor point 64.

First, a user attaches tang member 54 to standing part 16 of rope 10 below first anchor point 60. The location of attachment of device 20 to rope 10 should be higher than an elevation desired to store the item being lifted. Examples of a typical item are a bicycle or canoe, although other items are also suitable for lifting in the manner described herein. Typically, the desired elevation will correspond to a height immediately below secured or working end 12 of rope 10. Standing part 16 of rope 10 is passed over top 24 of first lobe 34 and passes through slot 52.

The user then makes a bight 18 around a safe lifting point, i.e., second anchor point 64, on the item to lift and pulls rope 10 taught. Rope 10 is then passed along guide channel 48 and around pulley surface 50. Rope 10 will then make contact with channel guide 48 parallel to existing rope 10. After rope 10 passes over pulley surface 50, rope 10 comes into contact with second locking jaws 44 defined by second lobe 42.

Running end 14 of rope 10 is then pulled to tighten rope 10 and to lift the item that is being secured. When a desired height of the item is achieved, rope 10 is locked into second locking jaws 44. The weight of the device being lifted will pull rope 10 tightly into second locking jaws 44, thereby securing the load.

iii. Description for Using the Device to Bypass a Damaged Part of Rope

Referring now to FIG. 4, the following will describe a method of using device 20A to bypass a damaged section 70 of rope 10. If rope 10 is in use and damaged section 70 is noticed, rope 10 may be configured such that damaged part 70 of rope 10 remains untensioned while rope 10 may still be used to secure a load.

First, a user attaches tang 54 to rope 10 at a location above damaged portion 70 on the working end 12 of the rope 10, e.g., several inches above damaged portion 70, so that a loop may be formed in rope 10, whereby the loop contains damaged part 70 of rope 10, thus removing tension from damaged portion 70 when rope 10 is subsequently tightened.

With the damaged part 70 of rope 10 hanging, i.e., not in tension, the user may pass rope 10 back into slot 52 and around top 24 of second lobe 42, where rope 10 engages second locking jaws 44. A second device 20B may be used to achieve desired tension in rope 10.

When desired tension is achieved, rope 10 is then locked into second locking jaws 44, leaving the damaged part of rope 10 hanging loose, i.e., not part of tightened rope 10 and thus not subject to failure.

iv. Description to Attach Two Different Sizes of Rope or to Extend a Length of Rope

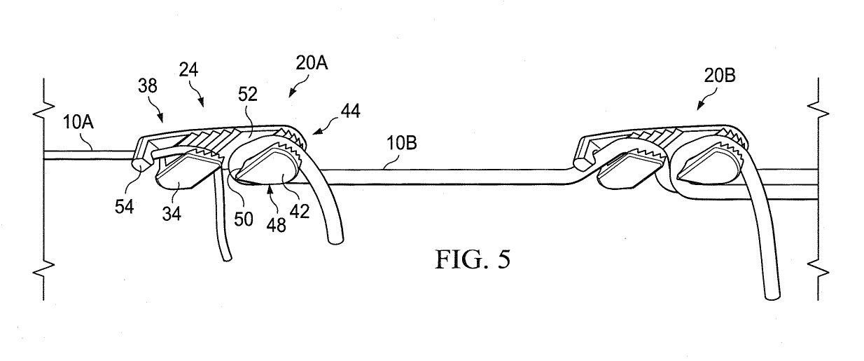

Referring now to FIG. 5, shown is a method for attaching two different sizes of rope 10, e.g., rope 10A and rope 10B, or to extend a length of rope 10 with device 20. A user first slips rope 10A into tang 54 of device 20A over top 24 of first lobe 34 and down through slot 52. Rope 10A is then snugged into first locking jaws 38. The user then places rope 10B adjacent second guide channel 48 around pulley surface 50, through slot 52, and into second locking jaws 44 on top 24 of second lobe 42. This method extends a length of rope 10A by the length of rope 10B used. The method can be executed as many times as needed with multiple devices 20 to extend rope 10 as necessary. Each of rope sections 10A, 10B may have the same or different diameters.

A second device 20B can be used to tighten rope 10 to desired tension as depicted in FIG. 5. Alternatively, if rope 10B is secured at second anchor point 64, only one device 20 is necessary to effectively tighten rope 10 when extending a length of rope 10.

Device 20 is not limited for use with the specified sizes of rope 10 discussed herein. Device 20 may accept different sizes of rope 10. It is further anticipated that devices 20 may be scaled up or down as necessary for production of a device 20 that accepts only relatively smaller sizes of rope 10, such as rope that is typically referred to as string, twine or cord. The use of relatively larger and smaller devices 20 will be the same as described in this application.

Device 20 may be used in series with the same rope 10 when securing multiple items as shown in FIGS. 4 and 5. When using device 20 in this manner, it is desirable to maintain rope 10 in a substantially parallel orientation with respect to a longitudinal axis of device 20 and to use the same anchor point prior to securing a different load. If rope 10 is pulled perpendicular to device 20, rope 10 will tend to pull from the jaws in locking point 28.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A rope tightening and securing device comprising:
a base member having a top, a bottom, a first end and a second end;
a first lobe proximate said first end of said base member, said first lobe having a first groove for receiving a segment of a rope;
a second lobe proximate said second end of said base member, said second lobe having a second groove for receiving a segment of said rope;
wherein said first lobe and said second lobe have a slot therebetween; and
wherein a segment of said rope may be pressed into said first groove of said first lobe, passed through said slot, pulled around said second lobe and pressed into said second groove of said second lobe.

2. The device according to claim 1 further comprising:
a tang protruding from said first end, said tang and said first lobe defining a second slot for receiving a segment of said rope.

3. The device according to claim 1 wherein:
said second lobe has a smooth channel on a lower end.

4. The device according to claim 1 wherein:
said second lobe defines a pulley point for permitting rope to slide across with minimal friction.

5. The device according to claim 1 wherein at least one of said first groove and said second groove have gripping members on inside surfaces thereof.

6. A method of securing material with a rope comprising the steps of:
securing a working end of the rope to an anchor point;
passing the rope over the material to be secured;
directing the rope through a passageway between a first lobe and a second lobe of a device and around a lower portion of said second lobe;
passing the rope through a second anchor point;
directing the rope under said second lobe and back into said passageway;
pulling the rope around said second lobe and engaging the rope in a second groove accessible from a top of said second lobe;
continuing to pull on the rope to tighten the rope around said material; and
securing the rope in said second groove.

7. The method according to claim 6 wherein:
said material is an object suspended from a vertical anchor point;
said bight surrounds a safe lifting point on said material; and
said step of pulling the rope lifts said material.

8. The method according to claim 6 wherein:
said step of pulling the rope slides the rope over a pulley point.

9. A method of securing rope comprising:
slipping a first segment of the rope into a tang of a device;
locating said first segment into a first groove in a first lobe of said device; and
locating a second segment of the rope into a second groove in a second lobe of said device.

10. The method according to claim 9 wherein:
said rope has a damaged section to be bypassed;
loosening said rope from said second lobe;
leaving said damaged section of said rope hanging in a loose condition;
directing said rope around a second end of said device and into said second groove;
directing said rope through a passageway between said first lobe and said second lobe of said second device and around a lower portion of said second lobe; and
maintaining said damaged section of the rope in said loose condition and pulling said rope around said second lobe and engaging said rope in a groove within said second lobe.

11. The method according to claim 9 wherein:
said first segment and said second segment of said rope have different diameters.

12. A rope tightening and securing device comprising:
a base plate;
a tang member extending from a first side of said base plate proximate a first end of said base plate and proximate a top side of said base plate;
a middle clamping section extending from said first side of said base plate, said middle clamping section defining a pair of grooved jaws for receiving a rope from said top side;
an end clamping section extending from said first side of said base plate, proximate a second end of said base plate, said end clamping section defining a pair of grooved jaws for receiving a rope from said top side of said base plate;
a guide channel defined on a first end of said end clamping section;
wherein said middle clamping section and said end clamping section define a passageway therebetween on said first side of said base plate;
wherein said tang member, said middle clamping section, said end clamping section and said guide channel are adapted to receive a length of rope that runs under said tang member, over said middle clamping section and within said jaws of said middle clamping section, through said passageway, under said end clamping section, and out and away from the device to form a bight, said rope returning to said device to run under said end clamping section parallel to existing rope, through said passageway and around said end clamping section, where a running end of said rope exits a top of said end clamping section;
wherein said jaws of said middle clamping section are configured to prevent the rope from sliding towards said first end; and
wherein said jaws of said end clamping section are configured to prevent the rope from sliding toward said first end of said base plate.
